(19) United States
(12) Patent Application Publication
(10) Pub. No.: US 2024/0329834 A1
(43) Pub. Date: Oct. 3, 2024

(54) ERASURE ENCODING USING ZONE SETS

(71) Applicant: QUANTUM CORPORATION, Centenial, CO (US)

(72) Inventors: Ben Jarvis, Stillwater, MN (US); Stephen P. Lord, Lakeville, MN (US); Yingping Lu, Markham (CA); Scott A. Bauer, Prior Lake, MN (US)

(21) Appl. No.: 18/624,377

(22) Filed: Apr. 2, 2024

Related U.S. Application Data
(60) Provisional application No. 63/592,863, filed on Oct. 24, 2023.
(60) Provisional application No. 63/456,762, filed on Apr. 3, 2023.
(60) Provisional application No. 63/456,524, filed on Apr. 2, 2023.

(51) Int. Cl. G06F 3/06

(52) U.S. Cl. CPC G06F 3/0604; G06F 3/0631; G06F 3/0689

(57) ABSTRACT

Systems and methods for initializing, creating, and lock-free writing of data in distributed data storage system. Methods utilize zone sets to write data according to data storage policies in a lock-free manner. The distributed scale-out data storage system includes various software modules and libraries that enable enhanced data management efficiencies and methods for performing data management tasks.

### RELATED APPLICATIONS

This application claims priority to U.S. Provisional Application Ser. No. 63/456,524, filed on Apr. 2, 2023, entitled, “SCALABLE DATA STORAGE SYSTEMS AND METHODS,” U.S. Provisional Application Ser. No. 63/456,762, filed on Apr. 3, 2023, entitled, “SCALABLE DATA STORAGE SYSTEMS AND METHODS,” U.S. Provisional Application Ser. No. 63/592,863, filed on Nov. 1, 2023, entitled, “SCALABLE DATA STORAGE SYSTEMS AND METHODS.” U.S. patent application Ser. No. ______ entitled “DISTRIBUTED DATASTORE FOR A SCALE-OUT DATA STORAGE SYSTEM” filed concurrently herewith; and U.S. patent application Ser. No. ______ entitled “SYSTEM AND METHOD FOR KEY-VALUE SHARD CREATION AND MANAGEMENT IN A KEY-VALUE STORE” filed concurrently herewith. As far as permitted, the contents of U.S. Provisional Application Ser. Nos. 63/456,524, 63/456,762, and 63/592,863 and U.S. patent application Ser. Nos. ______ and ______ are incorporated in their entirety herein by reference.

### BACKGROUND

End users of data storage products are required to manage and store rapidly growing volumes of data in data storage systems. Many of these data storage systems are built on proprietary hardware running proprietary software. The proprietary nature of these systems makes it difficult and expensive to upgrade to achieve better system performance because changing one component within the tightly integrated hardware and software cluster has a cascading effect that becomes time and cost prohibitive. As a result, many data storage systems are running on outdated, purpose-built hardware, which results in sub-par system performance. Looking to the future, with the intensive compute capabilities promised by innovations such as artificial intelligence and machine learning, these shortcomings become even more critical. It is, therefore, desirable to design a data storage software suite capable of achieving these optimizations, not only today, but over time as optimizations evolve, running on a wide variety of scalable data storage hardware platforms.

### SUMMARY

The present invention is directed toward methods for efficiently managing data storage within a distributed, scale-out data storage system. In various embodiments, the methods comprise a method for initializing a zone set in a distributed data storage system having a plurality of storage drives, the method comprising the steps of: querying a coordinator module to determine a zone set size using a configuration parameter; and writing a plurality of zone set parameters into a label zone of a zone set.

In certain embodiments, the method for initializing a zone set in a distributed data storage system having a plurality of storage drives, further comprises the configuration parameter includes one or more of a storage volume label, a zone set identifier, a cluster identifier, and a system identifier.

In additional embodiments, the method for initializing a zone set in a distributed data storage system having a plurality of storage drives, further comprises the plurality of the zone set parameters include one or more of a data redundancy value, a storage capacity for each zone within the zone set, a stripe size, and an identifier for each storage drive within the zone.

In yet alternate embodiments, the method for initializing a zone set in a distributed data storage system having a plurality of storage drives, further comprises the label zone is located at the lowest address on each of the plurality of storage devices.

In an alternative embodiment, there is a method of creating a zone set in a distributed data storage system having a plurality of storage drives, the method comprising the steps of creating the zone set comprised of individual zones by allocating a uniform amount of storage space into each individual zone, each individual zone being located on a different storage drive within the plurality of storage drives; allocating a write unit size to each zone of the zone sets; assigning zones having the same size write unit to the zone set; receiving a request to write a data segment; and creating a first reservation of data storage space within the zone set in response to the request to write data, the first reservation including a storage policy.

In an additional embodiment, the method of creating a zone set in a distributed data storage system having a plurality of storage drives further comprises the step of receiving an indication that the amount of data storage space within the first reservation has been filled.

In another embodiment, the method of creating a zone set in a distributed data storage system having a plurality of storage drives further comprises the step of creating a second reservation of data storage space in a different zone set.

In yet an additional embodiment, the method of creating a zone set in a distributed data storage system having a plurality of storage drives further comprises the step of writing data in a stripe in the first reservation of data storage space.

In an additional embodiment, the method of creating a zone set in a distributed data storage system having a plurality of storage drives further comprises a storage capacity of each stripe is the storage capacity of one write unit multiplied by a number of zones within a zone set.

In an additional embodiment, the method of creating a zone set in a distributed data storage system having a plurality of storage drives further comprises the steps of: calculating an amount of redundant data that must be written to the stripe in accordance with the storage policy; and writing the redundant data.

In yet an additional embodiment, the method of creating a zone set in a distributed data storage system having a plurality of storage drives further comprises the step of rotating a location of the storage space upon which redundant data is written.

In an additional embodiment, the method of creating a zone set in a distributed data storage system having a plurality of storage drives further comprises each zone set being comprised of five zones.

In another embodiment, the method of creating a zone set in a distributed data storage system having a plurality of storage drives further comprises the uniform amount of storage space is 256 megabytes.

In another embodiment, the method of creating a zone set in a distributed data storage system having a plurality of storage drives further comprises the storage policy is a data protection scheme.

In another embodiment, the method of creating a zone set in a distributed data storage system having a plurality of storage drives further comprises the data protection scheme is at least one of erasure encoding and mirroring.

In another embodiment, the method of creating a zone set in a distributed data storage system having a plurality of storage drives further comprises the step of decomposing the zone set.

In yet an alternate embodiment the methods comprise a method of performing lock-free writing in a distributed data storage, the method comprising the steps of: creating a write reservation for a data segment to be written to a zone set, the zone set being located on a plurality of different storage drives; receiving a data segment; writing the data segment into the write reservation according to a data storage policy scheme; writing a location information for the data segment into a key-value pair; and transacting the key-value pair.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of a representative embodiment of a data storage system having features of the present invention;

FIG. 2 is a simplified schematic illustration of a representative embodiment of a distributed datastore for scale-out data storage systems;

FIG. 3 is a simplified schematic illustration of a hardware framework for methods related to data storage using zone sets;

FIG. 4 is a flowchart illustrating a representative operational implementation of a method for initializing a zone set in a distributed data storage system having a plurality of storage drives;

FIG. 5 is a flowchart illustrating a representative operational implementation of a method for creating a zone set in a distributed data storage system having a plurality of storage drives; and

FIG. 6 is a flowchart illustrating a representative operational implementation of a method of performing lock-free writing in a distributed data storage.

While embodiments of the present invention are susceptible to various modifications and alternative forms, specifics thereof have been shown by way of examples and drawings and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a system and method that enables a data storage system, such as a distributed data storage system, to be utilized efficiently and effectively such that desired tasks can be performed within the storage system in an accurate and timely manner, with minimal waste of time, money, and resources. As described in detail in various embodiments herein, the present invention encompasses an incredibly adaptable data storage system and accompanying software, which are efficient, fast, scalable, cloud native, and well-suited for a data-driven future.

More particularly, the data storage systems described herein provide valuable solutions for unstructured data and are ideally suited for emerging high-growth use cases that require more performance and more scale, including AI and machine learning, modern data lakes, VFX and animation, and other high-bandwidth and high IOPS applications. In certain implementations, the data storage systems provide an all-flash, scale-out file, and object storage software platform for the enterprise. Leveraging advances in application frameworks and design that were not available even a few years ago, the modern cloud-native architecture of the present invention makes it an easy-to-use solution that overcomes the limitations of hardware-centric designs and enables customers to adapt to future storage needs while reducing the burden on over-extended IT staff.

It is appreciated that the data storage systems solve these challenges with an all-new scale-out architecture designed for the latest flash technologies to deliver consistent low-latency performance at any scale. These data storage systems introduce inline data services such as deduplication and compression, snapshots and clones, and metadata tagging to accelerate AI/ML data processing. Additionally, the data storage systems use familiar and proven cloud technologies, like microservices and open-source systems, for automating deployment, scaling, and managing containerized applications to deliver cloud simplicity wherever deployed.

In some embodiments, the software operates on standard high-volume flash storage servers enabling quick adoption of the latest hardware and storage infrastructure for future needs. In alternate embodiments, the optimizations disclosed can be utilized on myriad storage configurations including any combination of flash, hard disk drive (HDD), solid state drives (SSD) and the like. The data storage systems enable users to replace legacy disk-based storage systems with a software-defined performance suite, which is platform agnostic, and that provides faster performance, greater scale, and a more sustainable and green solution that is both power and real estate efficient.

The description of embodiments of the data storage systems is illustrative only and is not intended to be limiting. Other embodiments of the data storage system will readily suggest themselves to skilled persons having the benefit of this disclosure. Reference will now be made in detail to implementations of the data storage system as illustrated in the accompanying drawings. The same or similar reference indicators will be used throughout the drawings and in the following detailed description to refer to the same or like parts.

In the interest of clarity, not all routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

At a high level, embodiments of the present invention enable myriad efficiencies, which in turn increase speed, reliability, scalability, and flexibility. For example, the custom-built software suite enables at least the following, without limitation:
support for familiar key-value semantics such as GET, PUT, DELETE, SEARCH;
fast atomic transaction support;
copy-on write cloning support;
support for delta enumeration;
read scalability;
write scalability;
implementation in user space, kernel space, or a combination thereof;
zero-copy functionality;
flexible read caching; and
lock free writing.

The systems and methods disclosed integrate seamlessly into a variety of data storage system architectures, e.g., all flash, SSD, HDD, and combinations thereof. Embodiments are designed to deliver the same high-performance advantages in a platform-agnostic way. From a data storage operator's perspective, embodiments provide numerous advantages, including without limitation:
reduced expense;
enhanced customer choice and preference options;
reduction in single-source concerns and considerations;
flexibility in growing and evolving storage infrastructure without having to replace an entire storage infrastructure; and
enables use of public cloud IaaS.

It is appreciated by those skilled in the art that logic and algorithms are concepts or ideas that can be reduced to code, which in turn, can be packaged in modules or libraries. A “library” is a combination of executable computer code (logic) coupled with an interface. Modules and libraries, logic, code, and algorithms can be combined in programs, processes, Kubernetes pods, or servers to perform a specific purpose. Systems include programs, processes, Kubernetes pods, and servers running on nodes, clusters, or clouds to solve a particular problem. In embodiments described throughout, all modules and libraries are able to run in user space, the kernel or a combination of both.

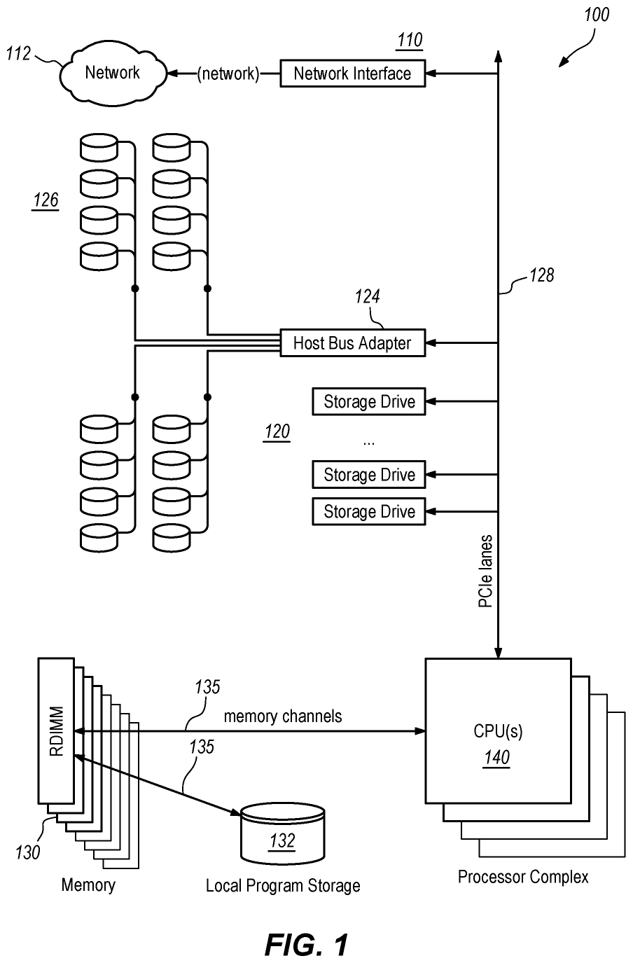

FIG. 1 is a simplified schematic illustration of a data storage system 100 upon which software innovations of a distributed datastore for a scale-out data storage system can be executed. The data storage system 100, when coupled with the software innovations of the distributed, scale-out data storage system, competes favorably with recent all-flash file and object storage solutions that rely on proprietary or esoteric hardware.

The data storage system 100 consists of a network interface 110. In one embodiment, the network interface 110 could be one or more remote direct memory access network interface controllers (RNIC). The network interface 110 provides connectivity to a network 112 and from there to an end user, e.g., a client computer, a machine learning module, an Artificial Intelligence (AI), an enterprise, and the like, as non-exclusive examples.

The data storage system 100 and associated software embodiments described herein work over any kind of presently known network 112, including personal area network (PAN), local area network (LAN), wireless local area network (WLAN), campus area network (CAN), metropolitan area network (MAN), wide area network (WAN), storage-area network (SAN), system area network (SAN), passive optical local area network (POLAN), enterprise private network (EPN), and virtual private network (VPN). Those of skill in the art will recognize the adaptability of what is taught herein as network development evolves over time.

Storage for the data storage system 100 can be, for example, and without limitation, one or more storage drives 120 devices. In an embodiment, the plurality of storage drives 120 includes non-volatile memory express (NVMe) flash drives, without limitation. In alternate embodiments, the data storage system 100 could include PCI attached storage. In an alternate embodiment, storage can include storage drives 126, which could be one or more disk drives 126. In embodiments, the one or more disk drives 126 could be, without limitation, such as a hard disk drive (HDD), hybrid hard drive (HHD), or solid-state drive (SSD) drives, or any combination thereof. In yet another embodiment, the data storage system 100 could use both storage drives 120 and one or more disk drives 126.

Connectivity for the components of the hardware platform 100 can be provided by a peripheral component interconnect express (PCIe) connection 128, which can also be referred to as PCIe lanes. Storage drives 126 could connect to the PCIe connection 128 through a host bus adapter (HBA) 124.

The data storage system 100 has a processor complex 140, which includes one or more computer processing units. The processor complex 140 executes the logic modules and libraries discussed further below.

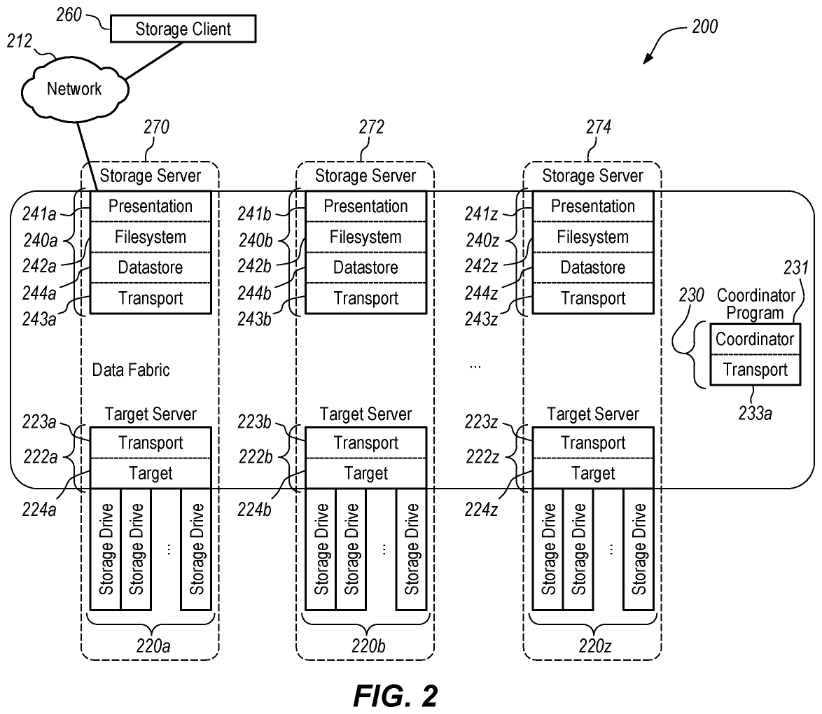

The data storage system 100 also has local memory storage capabilities in the form of memory devices 130 and local program storage 132. In certain embodiments, the logic modules and libraries, which will be discussed in more detail with reference to FIG. 2, that enable the functionality of the distributed datastore for scale-out storage can be stored in I memory devices 130, or in local program storage 132, or a combination of both. In an embodiment, memory devices 130 can include one or more registered dual inline memory modules (RDIMM) devices, as one non-exclusive example. The memory devices 130 are connected to local program storage 132 and processing complex 140 via memory channels 135.

FIG. 2 is a simplified schematic illustration of a distributed datastore 200 for the scale-out data storage system 100, sometimes referred to as “distributed datastore.” For illustrative purposes, some of the hardware aspects of the data storage system 100 have been depicted in FIG. 2 to provide clarity regarding the location of logic modules and libraries as well the tangible changes affected by those logic modules and libraries on the data storage system 100.

The distributed datastore 200 includes at least three storage nodes 270, 272, 274. Each storage node 270, 272, 274 includes a storage server 240a, 240b, and 240z, respectively, and a target server 222a, 222b, and 222z. Each of the storage nodes 270, 272, and 274 also has a plurality of storage drives 220a, 220b, 220z, respectively, attached to them. In an embodiment, storage drives 220a, 220b, 220z include NVMe flash drives, without limitation.

In an embodiment, one or more of storage nodes 270, 272, 274 is a load balancing node used to equally distribute data storage and IOPS within the data storage system. In an additional embodiment, one or more storage nodes 270, 272, 274 is a deployment node used to automate initialization management functions for the data storage system 100. Hardware communication within the data storage system 100 is accomplished among, for example, storage nodes 270, 272, 274, over data fabric 250.

The distributed datastore 200 is accessible by a storage client 260 through a network 212. In one embodiment, the storage client 260 can include a Network Attached Server (NAS) server and storage servers 240a, 240b, 240z can include a NAS server, as one non-exclusive example. The storage client 260 provides connectivity to the data storage system 100 enabling external clients (not shown) to access the data storage system 100. External clients can include, without limitation, individual computer systems, enterprises, Artificial Intelligence (AI) modules, or any other configurate enabled to run one or more of the networks 212 to perform typical data storage operations on the data storage system 100 using the distributed datastore 200.

In an embodiment, network 212 is a local area network (LAN). Those of skill in the art will recognize, in additional embodiments, network 212 includes, but are not limited to, personal area network (PAN), wireless local area network (WLAN), campus area network (CAN), metropolitan area network (MAN), wide area network (WAN), storage-area network (SAN), system area network (SAN), passive optical local area network (POLAN), enterprise private network (EPN), and virtual private network (VPN). Those of skill in the art will recognize the adaptability of what is taught herein as network development evolves over time.

Storage servers 270, 272, 274 include software modules and libraries used to manage the data storage system. Specifically, presentation layer 241a, 241b, 241z is a module of code stored in local program storage 132. Each presentation layer 241a, 241b, 241z can be configured to operate using a multitude of protocols, e.g., open source, proprietary, or a combination thereof, as non-limiting examples. By way of example, and without limitation, these protocols include Network File System (NFS), Server Message Block (SMB), Amazon Simple Storage Service (S3), and GUI enabled protocols.

Storage servers 270, 272, 274 also include transport libraries 243a, 243b, 243z. The transport libraries 243a, 243b, 243z enable the transfer of information from point-to-point within the distributed datastore 200. Transport libraries 243a, 243b, 243z form a communication infrastructure within the data storage system 100 and the distributed datastore 200. Transport libraries 243a, 243b, 243z provide a common API for passing messages between a server and a client end point, as those terms are generically used by those skilled in the art.

In one embodiment, transport libraries 243a, 243b, 243z remote direct memory access (RDMA). In another embodiment, transport libraries 243a, 243b, 243z use TCP/UNIX sockets. In embodiments, transport libraries 243a, 243b, 243z allow threads within the distributed datastore 200 to create queues and make connections. Transport libraries 243a, 243b, 243z move I/O requests and responses between initiators and targets. Transport libraries 223a, 223b, 223z and 233a, perform in the same fashion as described with regard to 243a, 243b, 243z, with one exception. Transport library 233a, which is part of coordinator program 230, is used to facilitate communication related to the tasks of the coordinator module 231.

Target servers 223a-223z also include a storage modules 224a-224z, respectively. Storage modules 224a-224z perform a lock-free multi-queue infrastructure for driving storage drives 220a-220z.

The coordinator program 230 includes a transport library 233a as well as a coordinator module 231. In an embodiment, the coordinator module 231 is a coordinator shard, which is updated by the coordinator module 231. While FIG. 2 depicts a single coordinator module 231, in some embodiments, there are sub-coordinator modules working in a hierarchical fashion under the direction of a lead coordinator module 231. The coordinator module 231, either on its own or in conjunction with the datastore library 244a-244z performs several data storage 100 management functions, including without limitation:
conflict resolution for operations such as writing data to the data storage system 100;
allocating space on storage drives 220a-220z for writing data;
determining a data redundancy scheme for data when it is written;
coordinating data stripe length and location;
supporting lock-free writing for data;
tracking data storage location;
coordinating access permissions for data reads such as what data can be accessed by which storage client 260 or ultimate end-user;
data compaction, also referred to by those skilled in the art as garbage collection; and
coordinate data write permissions, such as what data can be written by which storage client 260 or ultimate end user.

The datastore library 244a-244z, either on its own or in conjunction with the other modules and libraries within the distributed datastore 200 performs several data storage 100 management functions, including without limitation:
erasure encoding data;
encrypting data;
data deduplication;
compaction, also called garbage collection;
determining a delta enumeration of data snapshots; and
data compression.

In an embodiment, the datastore library 244a-244z implements a key-value store having a plurality of key-spaces, each key-space having one or more data structure shards. In an alternate embodiment, the data store library 244a-244z library implements a key-value store having a plurality of key-spaces, each key-space having one or more b+ tree shards. In one embodiment, datastore library 224a-224z is an object storage database. In another embodiment, datastore library 244a-z is a NoSQL database. In an embodiment, datastore library 244a-244z is a distributed, coherent key-value store specialized for applications like filesystem library 242a-242z.

In some embodiments, erasure encoding is a process involving writing data into zones and zone sets wherein the data is written in a distributed fashion in data stipes according to a data redundancy scheme. In embodiments, data is written in a loc-free fashion.

By way of background, a file system is a recursive structure of directories, also called “folders,” used to organize and store files, including an implicit top-level directory, sometimes called the “root directory.” Any directory in a file system can contain both files and directories, the number of which is theoretically without limit. Both directories and files have arbitrary names assigned by the users of the filesystem. Names are often an indication of the contents of a particular file.

Filesystems store data often at the behest of a user. Filesystems also contain metadata such as the size of the file, who owns the file, when the file was created, when it was last accessed, whether it is writable or not, perhaps its checksum, and so on. The efficient storage of metadata is a critical responsibility of a filesystem. The metadata of filesystem objects (both directories and files) are stored in inodes (short for “information nodes”). Inodes are numbered, which is all that is required to find them, and there are at least two types of inode: file inodes and directory inodes.

A file inode contains all metadata that is unique to a single file-all of the data listed above, and potentially many more, notably including an ordered list of blocks or extents where the data can be found. A directory inode contains metadata that is unique to a single directory-items such as who can add files or subdirectories, who can search the directory (e.g., to find an executable file), and notably, all of the names of the files, and subdirectories in the directory, each with its inode number.

With this abstraction, a filesystem basically comprises two kinds of data: inodes, which contain information about directories, and data files. Filesystems also contain information about the relationships between inodes and data files. Data files are typically written in data blocks, which are fixed size, or as data extents, variable length. The inodes store all of the metadata for all objects in the filesystem. Turning to filesystem library 242a-242z, in one embodiment, filesystem library 242a-242z is implemented as an application of a datastore library 244a-244z.

FIG. 2 depicts the distributed datastore 200 as being a unified collection of logic modules, libraries, storage, and interconnecting fabric. In alternate embodiments, each individual logic module or library within the distributed datastore 200 could be distributed across various interconnected hardware components, such as storage client 260 or other hardware devices connected to network 212, e.g., an individual computer system, a machine learning module, an AI module, and enterprise, a cloud, and the like. Those of skill in the art will recognize the infinite possibilities for distributing the components of the distributed, scale-out data storage system across myriad software, hardware, and firmware configurations.

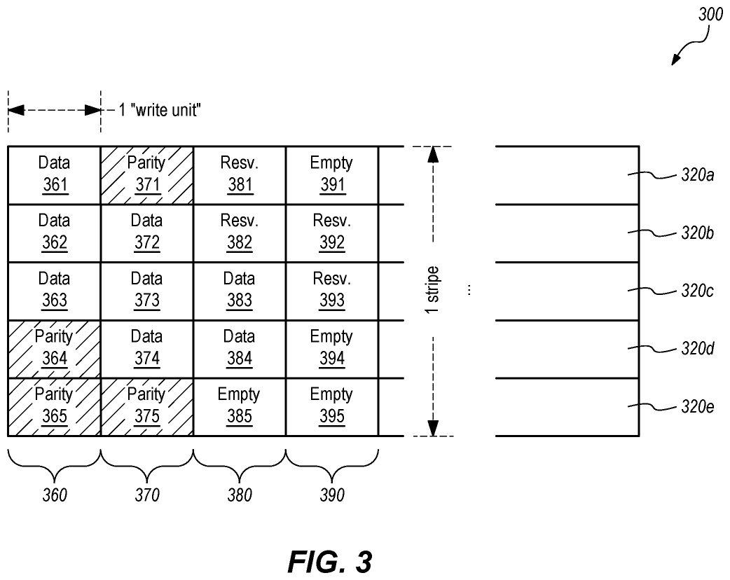

FIG. 3 is a schematic illustration designed to provide a conceptual hardware framework for methods related to zone sets 300, discussed in more detail below. At their core, zone sets 300 are a collection of storage spaces located on storage drives 320a-320e. FIG. 3 depicts an embodiment of zone sets 300 spread across five storage drives, 320a-320e. In alternate embodiments the number of storage drives could be as little as three storage drives 320a-320e, with no upper limit. FIG. 3 shows a total of four individual zone sets 360, 370, 380, 390. In alternate embodiments, there could be as few as one zone set 360, with no upper limit.

When a zone set 360, 370, 380, 390 is initialized, the coordinator module 231a determines the size for the zone sets 360, 370, 380, 390. In addition, the coordinator module 231 writes a plurality of zone set parameters into a label zone of a zone set 360, 370, 380, 390. In embodiments, the label for each zone set 360, 370, 380, 390 is located in the lowest storage space allocations for each of the storage drives 320a-320e, which form the storage space upon which zone sets 360, 370, 380, 390 are built. In an embodiment, zone set parameters include, without limitation, a storage volume label, a zone set identifier, a cluster identifier, and a system identifier.

Zone sets, 360, 370, 380, 390, are divided into individual zones. Zone set 360 is comprised of zones 361, 362, 363, 364, 365. Zone set 370 is comprised of zones 371, 372, 373, 374, 375. Zone set 380 is comprised of zones 381, 382, 383, 384, 385. Zone set 390 is comprised of zones 391, 392, 393, 394, 395. Each zone 361, 362, 363, 364, 365, 371, 372, 373, 374, 375, 381, 382, 383, 384, 385, 391, 392, 393, 394, 395 has a uniform size, referred to as a write size. In an embodiment, the write size of every zone 361, 362, 363, 364, 365, 371, 372, 373, 374, 375, 381, 382, 383, 384, 385, 391, 392, 393, 394, 395 in every zone set 360, 370, 380, 390 is the same. In these embodiments, it follows that the total storage capacity in each zone set 360, 370, 380, 390 is equal. In some embodiments, the write size is 256 megabytes.

Referring to FIG. 3, a stripe is defined as the data storage capacity of a zone 360, 370, 380, 390. Within every stripe, some of the information stored there will be data, and some will be data written in accordance with a storage policy. One example of a storage policy, without limitation is erasure encoding. A variation of a storage policy in an alternate embodiment a storage policy could provide for data mirroring.

In an embodiment employing data mirroring, redundancy is created by mirroring the data that is to be committed or stored within the data storage system 100. In this embodiment, a zone set 360, 370, 380, 390 typically comprises an even number of zones 360-364, half of which would be committed data, the other half of which would be mirrored or redundant data.

In some embodiments, the write size can vary depending upon the nature of the storage drives. In these embodiments, write size varies depending on the type of storage drive 320a-320e upon which the data is stored. Some of the considerations related to the storage drives 320a-320e that go into optimizing write size are, without limitation, storage drive 320a-320e performance, endurance, capacity, or other characteristic of the storage drive 320a-320e.

In an embodiment, zone sets 360, 370, 380, 390 are composed of zones 361, 362, 363, 364, 365, 371, 372, 373, 374, 375, 381, 382, 383, 384, 385, 391, 392, 393, 394, 395 having the same write unit values. In an embodiment, data is written into write reservation, which is a portion of data storage space located in zone set 361, 362, 363, 364, 365, 371, 372, 373, 374, 375, 381, 382, 383, 384, 385, 391, 392, 393, 394, 395. Write reservations can be created by a filesystem library 242a-242z working in coordination with a coordinator module 231. In alternate embodiments, write reservations are created individually by either a filesystem library 242a-242z or a coordinator module 231.

When data is written into a first write reservation, it is written in a data stripe. In an embodiment, a write unit is 4 kilobytes. Assuming a 3+2 erasure encoding storage scheme, as shown in FIG. 3, a total of 12 kilobytes of data will be stored in zone sets 361, 362, 363. Parity data will be stored in zone sets 364 and 365. In some embodiments, the amount of data storage space associated with a particular write reservation will be exhausted and zone set 360 will be full.

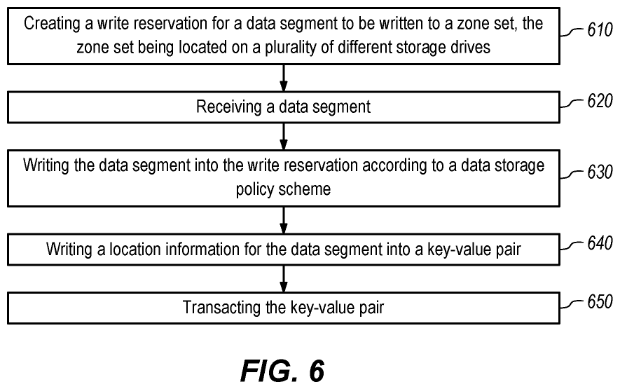

In an alternate embodiment, the first write reservation will not be filled. In that instance, when a second write reservation is created and data are being written to zone set 360, the data will be written at the first available space on the first reservation. In an alternate embodiment, when the first write reservation fills up before all of the data seeking to be committed has been written into zone set 360, a second reservation can be created. In one embodiment, if there is remaining space in zone set 360, it is possible that the second reservation would correlate be for storage space within zone set 360. In an alternate embodiment, if full data stripe has been written in zone 360, a new data reservation will be made in a different zone set 370, 3809, 390. Data writing 630 will resume in discussed in more detail below with reference to FIG. 6.

When creating zone sets 360, 370, 380, 390, it can be advantageous to randomize the storage location of data written according to storage policies because if all back-up data, redundant data, parity data and the like were located on a single storage drive and that drive was compromised, it pose a much greater storage efficiency burden on the data storage system when compared with the scenario of interspersing data associated with storage policies randomly across all available storage drives.

In embodiments, zone sets can be decomposed under myriad circumstances, for example, data storage disk failures, data storage disk maintenance, the addition of data storage disks creating the opportunity for additional data storage zones to be created, a change in storage policies due to a reduction or increase of data storage capacity. In this way, methods herein accommodate distributed, scale-out data storage systems.

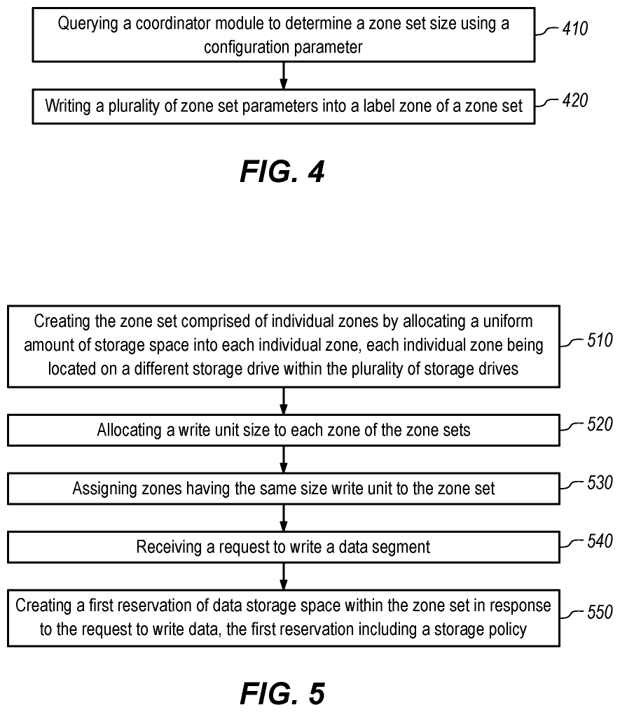

FIG. 4 is a flowchart showing the steps for initializing a zone set in a distributed data storage system having a plurality of storage drives. In an embodiment, initializing a data storage system includes querying 410 a coordinator module to determine a zone set size using a configuration parameter and writing 420 a plurality of zone set parameters into a label zone of a zone set.

In alternate embodiments for initializing a zone set, the configuration parameter includes, without limitation one or more of a storage volume label, a zone set identifier, a cluster identifier, and a system identifier.

In alternate embodiments for initializing a zone set, the plurality of the zone set parameters include one or more of: a data redundancy value, a storage capacity for each zone within the zone set, a stripe size, and an identifier for each storage drive within the zone.

In yet an additional embodiment for initializing a zone set the label zone is located at the lowest address on each of the plurality of storage devices.

FIG. 5 is a flowchart showing a method of creating a zone set in a distributed data storage system having a plurality of storage drives, the method comprising the steps of creating 510 the zone set comprised of individual zones by allocating a uniform amount of storage space into each individual zone, each individual zone being located on a different storage drive within the plurality of storage drives; allocating 520 a write unit size to each zone of the zone sets; assigning 530 zones having the same size write unit to the zone set; receiving 540 a request to write a data segment; and creating 550 a first reservation of data storage space within the zone set in response to the request to write data, the first reservation including a storage policy.

In an alternate embodiment, the method of creating a zone set in a distributed data storage system having a plurality of storage drives further comprises the step of receiving an indication that the amount of data storage space within the first reservation has been filled.

In another embodiment, the method of creating a zone set in a distributed data storage system having a plurality of storage drives further comprises the step of creating a second reservation of data storage space in a different zone set.

In yet an alternate embodiment, the method of creating a zone set in a distributed data storage system having a plurality of storage drives further comprises the step of writing data in a stripe in the reservation of data storage space.

In another embodiment, the method of creating a zone set in a distributed data storage system having a plurality of storage drives comprises the storage capacity of each stripe is the storage capacity of one write unit multiplied by the number of zones within a zone set.

In an alternate embodiment, the method of creating a zone set in a distributed data storage system having a plurality of storage drives further comprises the steps of calculating an amount of redundant data that must be written to the stripe in accordance with the storage policy; and writing the redundant data.

In yet an additional embodiment, the method of creating a zone set in a distributed data storage system having a plurality of storage drives further comprises the step of rotating the location of the storage space upon which redundant data is written.

In yet another embodiment, the method of creating a zone set in a distributed data storage system having a plurality of storage drives further comprises each zone set being comprised of five zones.

In an alternative embodiment, the method of creating a zone set in a distributed data storage system having a plurality of storage drives, the uniform amount of storage space is 256 megabytes.

In another embodiment, the method of creating a zone set in a distributed data storage system having a plurality of storage drives, the storage policy is a data protection scheme.

In yet a further embodiment, the method of creating a zone set in a distributed data storage system having a plurality of storage drives, the data protection scheme is at least one of erasure encoding or mirroring.

In an alternate embodiment, the method of creating a zone set in a distributed data storage system having a plurality of storage drives further comprises the step of the step of decomposing the zone set.

FIG. 6 depicts a method of performing lock-free writing in a distributed data storage, the method comprising the steps of: creating 610 a write reservation for a data segment to be written to a zone set, the zone set being located on a plurality of different storage drives; receiving 620 a data segment; writing 630 the data segment into the write reservation according to a data storage policy scheme; writing 640 a location information for the data segment into a key-value pair; and transacting 650 the key-value pair.

It is understood that although a number of different embodiments of the systems and methods for initializing, creating, and lock-free writing of data in distributed data storage system have been illustrated and described herein, one or more features of any one embodiment can be combined with one or more features of one or more of the other embodiments, provided that such combination satisfies the intent of the present technology.

While a number of exemplary aspects and embodiments of the systems and methods for initializing, creating, and lock-free writing of data in distributed data storage system have been discussed above, those of skill in the art will recognize certain modifications, permutations, additions, and sub-combinations thereof. It is, therefore, intended that the following appended claims and claims hereafter introduced are interpreted to include all such modifications, permutations, additions, and sub-combinations as are within their true spirit and scope.

What is claimed is:

1. A method for initializing a zone set in a distributed data storage system having a plurality of storage drives, the method comprising the steps of:
querying a coordinator module to determine a zone set size using a configuration parameter; and
writing a plurality of zone set parameters into a label zone of a zone set.

2. The method of claim 1, wherein the configuration parameter includes one or more of a storage volume label, a zone set identifier, a cluster identifier, and a system identifier.

3. The method of claim 1, wherein the plurality of the zone set parameters include one or more of: a data redundancy value, a storage capacity for each zone within the zone set, a stripe size, and an identifier for each storage drive within the zone.

4. The method of claim 1, wherein the label zone is located at the lowest address on each of the plurality of storage devices.

5. A method of creating a zone set in a distributed data storage system having a plurality of storage drives, the method comprising the steps of:
creating the zone set comprised of individual zones by allocating a uniform amount of storage space into each individual zone, each individual zone being located on a different storage drive within the plurality of storage drives;
allocating a write unit size to each zone of the zone sets;
assigning zones having the same size write unit to the zone set;
receiving a request to write a data segment; and
creating a first reservation of data storage space within the zone set in response to the request to write data, the first reservation including a storage policy.

6. The method of claim 5 further comprising the step of receiving an indication that the amount of data storage space within the first reservation has been filled.

7. The method of claim 6 further comprising the step of creating a second reservation of data storage space.

8. The method of claim 5 further comprising the step of writing data in a stripe in the first reservation of data storage space.

9. The method of claim 8 wherein a storage capacity of each stripe is the storage capacity of one write unit multiplied by a number of zones within a zone set.

10. The method of claim 8 further comprising the steps of:
calculating an amount of redundant data that must be written to the stripe in accordance with the storage policy; and
writing the redundant data.

11. The method of claim 10 further comprising the step of rotating a location of the storage space upon which redundant data is written.

12. The method of claim 5 wherein each of the zone sets is comprised of five zones.

13. The method of claim 5 wherein the uniform amount of storage space is 256 megabytes.

14. The method of claim 5 wherein the storage policy is a data protection scheme.

15. The method of claim 14 wherein the data protection scheme is at least one of erasure encoding and mirroring.

16. The method of claim 5 further comprising the step of decomposing the zone set.

17. A method of performing lock-free writing in a distributed data storage, the method comprising the steps of:
creating a write reservation for a data segment to be written to a zone set, the zone set being located on a plurality of different storage drives;
receiving a data segment;
writing the data segment into the write reservation according to a data storage policy scheme;
writing a location information for the data segment into a key-value pair; and
transacting the key-value pair.
